(19) United States
(12) Patent Application Publication
(10) Pub. No.: US 2025/0263808 A1
(43) Pub. Date: Aug. 21, 2025

(54) RUHRSTAHL-HERAEUS SNORKEL DESIGN

(71) Applicant: HarbisonWalker International Holdings, Inc., Pittsburgh, PA (US)

(72) Inventor: Donald Abrino, Curwensville, PA (US)

(73) Assignee: HarbisonWalker International Holdings, Inc., Pittsburgh, PA (US)

(21) Appl. No.: 19/057,490

(22) Filed: Feb. 19, 2025

Related U.S. Application Data
(63) Continuation of application No. PCT/US2025/016224, filed on Feb. 17, 2025.
(60) Provisional application No. 63/555,581, filed on Feb. 20, 2024.
(60) Provisional application No. 63/555,581, filed on Feb. 20, 2024.

(51) Int. Cl. C21C 7/00; C04B 37/02

(52) U.S. Cl. CPC C21C 7/0075; C04B 37/02; C04B 2237/343; C04B 2237/363; C04B 2237/406; C04B 2237/64; C04B 2237/706; C21C 2100/00

(57) ABSTRACT

A refractory component for forming a refractory lining includes a refractory brick, and a support member having at least one surface fixed to the refractory brick.

### RELATED APPLICATION DATA

This application claims the benefit of U.S. Provisional Application No. 63/555,581 filed Feb. 20, 2024, and is a continuation of International Application No. PCT/US2025/016224 filed Feb. 17, 2025, each of which is hereby fully incorporated herein by reference.

### FIELD OF THE INVENTION

The invention relates generally to metal-making processes and, more particularly, to a device and method for improving the durability of a Ruhrstahl-Heraeus snorkel.

### BACKGROUND OF THE INVENTION

The snorkel of a Ruhrstahl-Heraeus (RH) degasser is the highest wear part of a RH degasser, often being replaced many times before the rest of the unit requires a new refractory lining. The snorkel has two main failure points; one is the interior brick of the snorkel and the other is the outer refractory layer of the snorkel. Both can have their service life extended by repeated hot repair of the refractory by using either dry gunning or wet shotcrete. Often, even with this repair, a failure of the outer refractory lining is the typical reason for a complete failure of the snorkel.

Conventionally, the outer lining of the snorkel consists of a cast refractory lining that is most often a high alumina material, but can also be an alumina/magnesia spinel or a magnesia chrome spinel material. Steel anchors are welded to the interior steel barrel (also referred to as the “can”) of the snorkel to hold the refractory cast lining in place. The steel can in addition contain plurality of piping with output ports suitable for distribution of various gasses or functioning as a cooling system for the snorkel.

While the aforementioned materials are very resistant to the destructive effects of steel, after the submersion to the liquid steel in the ladle they are subject to the destructive effects of the slag on the top of the liquid steel. The ideal material for this application would be magnesia carbon refractory, such as the material used in the slag line of a steel ladle. High quality mag-carbon refractory, however, does not exist as a castable and, due to this being the outer lining of a cylinder brick construction, it is subject to mechanical failure. Such failure is due at least in part to the outer lining not being locked in place by compression (in contrast to the inner lining of the snorkel, which is locked in by compression and most often made of magnesia chrome spinel brick). Magnesia-carbon steel ladle slag line is also the inner lining of a cylinder and not subject of a mechanical failure as would be the case in outer lining of a RH degasser snorkel.

While some have experimented with using mag-carbon brick for the RH snorkel, it has not been widely adopted due to the insufficient anchoring of the brick into the construction. The insufficient brick anchoring, or absence of such anchoring will result in the failure of the snorkel.

### SUMMARY OF THE INVENTION

In accordance with the invention, a refractory component is provided that can be formed as a resin brick, a pitch bonded brick, a magnesium-carbon brick or an alumina-carbon brick, and yet can be securely fastened to an RH snorkel can. More particularly, a support is fixed to a refractory brick, such as a magnesia carbon brick or other brick suitable for use with an RH snorkel. To fix the support to the brick, anchors can be pressed into the brick where the anchors hold the support to a surface of the brick. Alternatively, the support can be co-molded with the brick such that the support is disposed at least partially in an interior space of the brick, and at least another portion of the support is accessible external to the brick. Mounting tabs then can be secured to the accessible portion of the support, and these mounting tabs then can be used to secure the support (and thus the brick) to the snorkel can.

According to one aspect of the invention, a refractory component for forming a refractory lining includes: a refractory brick; and a support member having at least one surface fixed to the refractory brick.

In one embodiment, the support member is co-molded with the refractory brick.

In one embodiment, the refractory component includes a plurality of anchors, wherein the plurality of anchors fix the support member to the refractory brick.

In one embodiment, the plurality of anchors are integrally formed with the support member.

In one embodiment, the anchors include a positive lock.

In one embodiment, the positive lock includes at least one of a hook, a wave rod, a tapered rod, or a headed rod.

In one embodiment, the support member includes a steel plate.

In one embodiment, the support member includes a planar member.

In one embodiment, the planar member is at least one-quarter inch thick.

In one embodiment, the at least one of the anchors or the support member is pressed into the brick.

In one embodiment, the refractory brick includes a resin brick, a pitch bonded brick.

In one embodiment, the brick includes a magnesium-carbon brick or an alumina-carbon brick.

In one embodiment, the refractory brick includes at least one mounting tab attached to the support member, the at least one mounting tab configured to mount the refractory component to a support structure.

According to another aspect of the invention, a Ruhrstahl-Heraeu (RH) snorkel, includes: a snorkel can having an inner radial surface, an outer radial surface, a top surface and a bottom surface; and an outer lining attached to at least one of the outer radial surface, or the bottom surface, where the outer lining is formed from a plurality of refractory components as described herein.

In one embodiment, the snorkel includes a cylinder.

In one embodiment, the snorkel includes a cooling device arranged on the outer radial surface of the snorkel can.

In one embodiment, the snorkel includes a monolithic refractory disposed at least in a space between the outer radial surface of the snorkel can and the refractory component.

According to another aspect of the invention, a method of forming a refractory component for a Ruhrstahl-Heraeu (RH) snorkel includes: fixedly attaching a support member to a refractory brick; and attaching a plurality of mounting tabs to the support member.

In one embodiment, the method includes securing the plurality of mounting tabs to an outer surface of the RH snorkel.

In one embodiment, fixedly attaching includes pressing the support member into the brick.

In one embodiment, fixedly attaching includes placing a first surface of the support member against a first surface of the refractory brick, and pressing anchors through the support member and into the refractory brick to secure the support member to the refractory brick.

In one embodiment, fixedly attaching includes co-molding the support member with the refractory brick.

In one embodiment, co-molding the support member into the refractory brick includes attaching anchors to the support member, and co-molding the support member and anchors into the refractory brick.

In one embodiment, the method includes attaching mounting tabs to a second surface of the support member.

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well-known process operations have not been described in details so as to not unnecessarily obscure the present invention.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1A illustrates a side and front view of a refractory component in accordance with an embodiment of the invention;

FIG. 1B is a front view of an exemplary support utilized in the refractory component of FIG. 1A;

FIG. 1C illustrates a side view of a refractory component having a support co-molded in the refractory brick in accordance with an embodiment of the invention;

FIGS. 2A-2D illustrate exemplary anchor shapes for positively locking the anchor into the refractory brick in accordance with embodiments of the invention;

FIG. 3 is a top view of a plurality of refractory components having a trapezoidal shape for mounting to a circular snorkel can;

FIG. 4 is a side sectional view of a snorkel can with a refractory component in accordance with an embodiment of the invention attached thereto;

FIG. 5 is a side and front view of a refractory component in accordance with another embodiment of the invention; and

FIG. 6 is a side sectional view of a snorkel can with a refractory component of FIG. 5 attached to the can.

### DETAILED DESCRIPTION OF PREFERRED EMBODIMENT

Various aspects of the invention now will be described more fully hereinafter. Such aspects of the invention may, however, be embodied in many different forms and should not be construed as limited to the embodiments set forth herein; rather, these embodiments are provided so that this disclosure will be thorough and complete, and will fully convey its scope to those skilled in the art.

The word “about” when immediately preceding a numerical value means a range of plus or minus 10% of that value, e.g., “about 50” means 45 to 55, “about 25,000” means 22,500 to 27,500, etc., unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

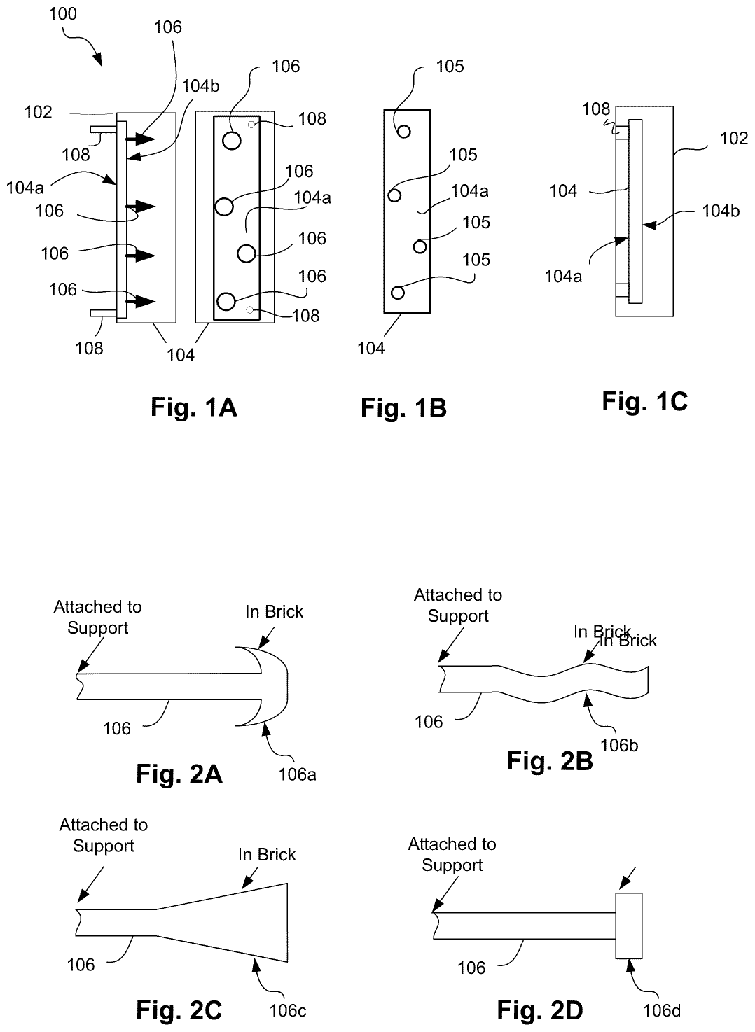

In accordance with the present invention, a refractory component for forming a refractory lining, for example, for an RH snorkel is described. Referring initially to FIGS. 1A and 1B, the refractory component 100 includes a refractory brick 102, which preferably is composed of materials that are resistant to the destructive effects of steel and steel ladle slag. For example, the refractory brick 102 may be formed from one or more of a resin brick, a pitch bonded brick, a magnesium-carbon brick or an alumina-carbon brick. The refractory brick 102 may have a shape and dimensions as required by the particular application.

Attached to the refractory brick 102 is a support member 104, such as a steel plate or the like. In the illustrated embodiment of FIG. 1A, the support member 104 has a first surface 104a for attachment to the refractory brick 102, and a second surface 104b disposed opposite the first surface 104a for attachment to a snorkel can or other metal-making equipment. The first surface of the support member 104 can have a surface contour that corresponds to a surface contour of a mounting surface of the refractory brick 102. In the illustrated embodiment the mounting surfaces of the support member 104 and the refractory brick are planar, but other contours are possible. Preferably, the support member 104 is dimensioned to enable rigid placement of the refractory brick 102.

In one embodiment, the support member 104 includes a plurality of through-holes 105. A plurality of anchors 106 are placed in the through holes 105, each anchor having a head portion that is larger than both the through-hole and the main body portion of the anchor. The anchors then are pressed/driven into the refractory brick 102, whereby the head portion secures the support member 104 to the refractory brick 102. Alternatively, the main body portion of each anchor may be generally uniform in thickness (i.e., no head portion) and once pressed/driven into the brick 102 they are secured to the support member 104, for example, using a threaded fastener or welding the two together. In another embodiment, the plurality of anchors 106 are formed integral with the support member 104, i.e., the support member and anchors are formed as a one-piece unit. The one-piece unit then is pressed into the refractory brick 102, whereby the anchors 106 secure the support member 104 to the refractory brick 102. In yet another embodiment, the support member 104 (with or without the anchors) is co-molded with the refractory brick 102, e.g., the support member 104 is placed in a brick mold and refractory material is added to the mold and formed around the support member. Such configuration is illustrated in FIG. 1C. In the embodiment of FIG. 1C the tabs 108 are attached to the support 104 prior to the support 104 being co-molded with the brick 102, the tabs 108 extending to a surface of the brick 102. A connection (e.g., a threaded connection, a weld, etc.) then can be made to these tabs to enable the refractory brick 102 to be secured to another object, such as the snorkel can.

The anchors 106 may include a positive lock. For example, the anchors 106 may have a hook or anchor shape, a tapered or wave shape, or have an end larger in diameter than the remaining remainder of the anchor. FIGS. 2A-2D illustrate exemplary positive-lock anchors, where the left portion of each figure would be secured to the support 104 and the right portion of each figure would be within the refractory brick 102. Specifically, FIG. 2A illustrates a positive lock in the form of a hook 106a, FIG. 2B illustrates a positive lock in the form of a wavy rod 106b, FIG. 2C illustrates a positive lock in the form of a tapered rod 106c, and FIG. 2D illustrates a positive lock in the form of a rod having a head 106d (i.e., an end larger than the remainder of the rod).

The anchors 106 for a given brick 102 and/or support member 104 all may be identical to each other, or there may be a mixture of different types of anchors. For example, some anchors may be longer than others, some may have a larger diameter than others, some may have a different profiles (e.g., tapered vs non-tapered), some may have different locking mechanisms, etc.

To mount the refractory component 100 onto a support structure, a plurality of mounting tabs 108 can optionally be attached to the second side 104a of the support 104. The mounting tabs 108 may be formed from steel or other metal. The mounting tabs 108 may be secured to the support 104 by a mechanical retainer and/or a weld. Alternatively, the mounting tabs 108 may be integrally formed with the support 104.

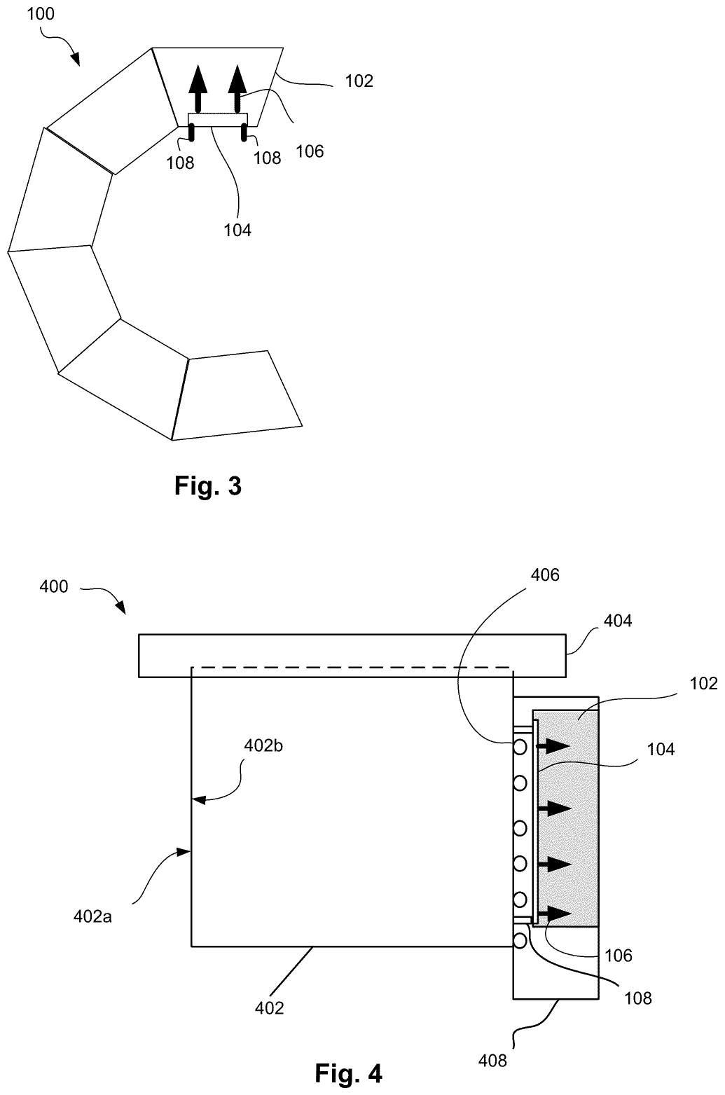

Referring briefly to FIG. 3, illustrated are a plurality of exemplary refractory components 100 arranged side-by-side, where each refractory component 100 has a trapezoidal shape. The trapezoidal-shaped refractory components 100, when arranged side-by-side as shown in FIG. 3, produce generally circular profile that conforms to a circular structure, such as snorkel can. As will be appreciated, other shapes of the refractory component 100 are possible depending on the specific application of the refractory component.

Moving now to FIG. 4, illustrated is an RH snorkel 400 having a cylindrical snorkel can 402 attached to a cylindrical flange 404, the snorkel can 402 having an outer radial surface 402a and an inner radial surface 402b. Refractory component 100 in accordance with the invention is attached to the outer radial surface 402a of the snorkel can 402. For clarity, only a single refractory component 100 is shown attached to the outer radial surface 402a of the snorkel can 402. In practice, however, a plurality of refractory components 100 would be attached to the entire outside radial surface 402a of the snorkel can 402 to ensure it is protected from molten steel and slag. The inner radial surface 402b of the snorkel can may be lined with conventional refractory brick. In the illustrated embodiment of FIG. 4, conduits 406 are arranged along the outer radial surface 402a of the snorkel can 402, i.e., between the surface 402a and the support 104. These optional conduits 406 can carry a coolant along the outer radial surface of the can 402 so as to prevent the can 402 from being subjected to excessive temperatures. In addition (not shown) there is additional piping on the inner radial surface of the can, with outlet ports extending through the inner refractory of the snorkel, for the distribution of lifting argon gas helpful in the degassing (mainly in decarburization) of ultra-low carbon steel grades. When the refractory components 100 are installed on snorkels 400 with such cooling conduits (or other cooling means), the mounting tabs 108 can be dimensioned to accommodate the conduits 406. It is noted that while the refractory components 100 are shown as being attached to the outer radial surface of the snorkel 400, the refractory components 100 may be attached at other locations on the snorkel. For example, the refractory components 100 may be attached to a bottom surface of the snorkel (tip) in the lower end of monolithic refractory 408.

Formed around the refractory components 100 and in a space between the outer radial surface 402a and the refractory component 100 is a monolithic refractory 408, which forms the outer-most layer of the snorkel can 402 (both above and below the slagline and between the can 402 and the refractory brick 102 and the support member 104). The monolithic refractory above and below the refractory component 100 may be anchored in a conventional manner (not shown).

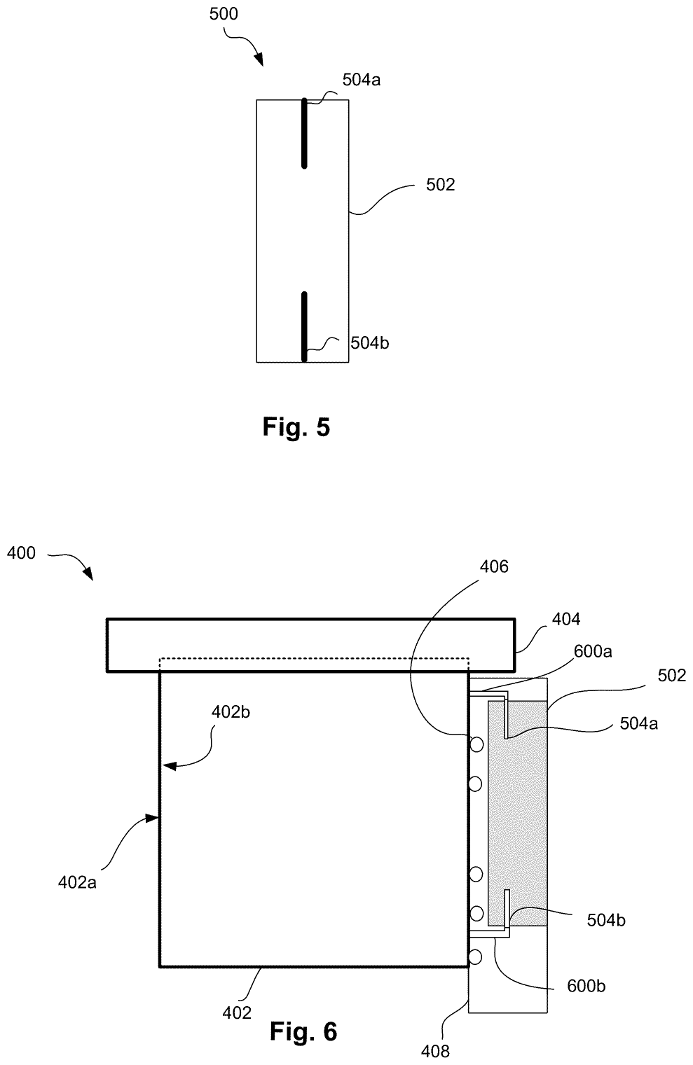

Moving now to FIG. 5, illustrated is a refractory component 500 in accordance with another embodiment of the invention. Like the refractory component 100 of FIGS. 1A and 1B, the refractory component 500 includes a refractory brick 502, which preferably is composed of materials that are resistant to the destructive effects of steel and slag, e.g., the refractory brick 502 may be formed from one or more of a resin brick, a pitch bonded brick, a magnesium-carbon brick or an alumina-carbon brick. The refractory brick 502 may have a shape and dimensions as required by the particular application.

To mount the refractory brick 500, support members 504a, 504b are attached to opposing ends of the refractory brick 502. For example, the support members 504a, 504b may be steel rods that are inserted into the top and bottom of the refractory brick 502 by drilling holes in the brick after manufacturing. Alternatively, the support members 504a, 504b can be co-molded into the refractory brick 502. These support members 504a, 504b, which extend to an outer surface of the brick, then can be welded to tabs 600a, 600b for attachment to the can 402 as shown in FIG. 6. To co-mold the support members 504a, 504b into the brick 502, a fixing device (not shown) is attached to the support members 504a, 504b to positionally fix the support members 504a, 504b. Such attachment, for example, may be by means of a threaded fastener, a weld or other conventional means. Refractory then is molded around the support members to form the brick. The fixing device may attach to the support members 504a, 504b at a region that eventually forms an outer surface of the brick, thereby enabling the support members to be attached to another device. Refractory castable 408 can be used to cast above and below the brick 502 and between the can 402 and the brick 502 as in the first embodiment.

A method for making the refractory component 100, 500 includes forming or obtaining a refractory brick 102, 502 having a desired shape, and forming or obtaining a support 104, 504a, 504b. As discussed herein, the support may be a steel plate 104 corresponding in shape of a shape of the refractory brick 102 and/or a rod 504a, 504b. The refractory brick 102, 502 may be pre-formed (i.e., formed prior to attachment of the support with the brick), and in one embodiment one surface of the support 104 may be placed against a surface of the brick 102 and fixedly attached thereto. For example, in the embodiment of FIG. 1A the support 104 can be fixedly attached to the refractory brick 102 through a plurality of anchors 106 arranged in through-holes 105 of the support 104, where the anchors are pressed into the brick 102. In the embodiment of FIG. 5 in which the support is in the form of a steel rod 504a, 504b, a bore hole may be created or formed in opposing ends of the brick 502 and rods 504a, 504b are inserted into the bore holes. The holes may be sized slightly smaller than the rod to provide an interference fit, and the supports 504a, 504b are pressed into the respective bore holes to secure the two to each other. In yet another embodiment, when forming (molding) the refractory brick 102, 502 the support 104, 504a, 504b and/or anchors may 106 be co-molded into the brick 102, 502, thereby securing the support to the refractory brick. Mounting tabs 108, 600a, 600b then can be attached to an outer-most surface of the support 104, 504a, 504b for securing the refractory component 100, 500 to the snorkel can 400.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

1. A refractory component for forming a refractory lining, comprising
a refractory brick; and
a support member having at least one surface fixed to the refractory brick.

2. The refractory component according to claim 1, wherein the support member is co-molded with the refractory brick.

3. The refractory component according to claim 1, further comprising a plurality of anchors, wherein the plurality of anchors fix the support member to the refractory brick.

4. The refractory component according to claim 3, wherein the plurality of anchors are integrally formed with the support member.

5. The refractory component according to claim 3, wherein the anchors comprise a positive lock.

6. The refractor component according to claim 5, wherein the positive lock comprises at least one of a hook, a wave rod, a tapered rod, or a headed rod.

7. The refractory component according to claim 1, wherein the support member comprises a steel plate.

8. The refractory component according to claim 1, wherein the support member comprises a planar member.

9. The refractory component according to claim 8, wherein the planar member is at least one-quarter inch thick.

10. The refractory component according to claim 1, wherein the at least one of the anchors or the support member is pressed into the brick.

11. The refractory component according to claim 1, wherein the refractory brick comprises a resin brick, a pitch bonded brick.

12. The refractory component according to claim 11, wherein the brick comprises a magnesium-carbon brick or an alumina-carbon brick.

13. The refractory component according to claim 1, further comprising at least one mounting tab attached to the support member, the at least one mounting tab configured to mount the refractory component to a support structure.

14. A Ruhrstahl-Heraeu (RH) snorkel, comprising:
a snorkel can having an inner radial surface, an outer radial surface, a top surface and a bottom surface; and
an outer lining attached to at least one of the outer radial surface, or the bottom surface, where the outer lining is formed from a plurality of refractory components according to claim 1.

15. The RH snorkel according to claim 14, wherein the snorkel comprises a cylinder.

16. The RH snorkel according to claim 14, further comprising a cooling device arranged on the outer radial surface of the snorkel can.

17. The RH snorkel according to claim 14, further comprising a monolithic refractory disposed at least in a space between the outer radial surface of the snorkel can and the refractory component.

18. A method of forming a refractory component for a Ruhrstahl-Heraeu (RH) snorkel, comprising:
fixedly attaching a support member to a refractory brick; and
attaching a plurality of mounting tabs to the support member.

19. The method according to claim 18, further comprising securing the plurality of mounting tabs to an outer surface of the RH snorkel.

20. The method according to claim 18 any one of claims 18-19, wherein fixedly attaching includes pressing the support member into the brick.

21. The method according to claim 18, wherein fixedly attaching includes placing a first surface of the support member against a first surface of the refractory brick, and pressing anchors through the support member and into the refractory brick to secure the support member to the refractory brick.

22. The method according to claim 18, wherein fixedly attaching includes co-molding the support member with the refractory brick.

23. The method according to claim 22, wherein co-molding the support member into the refractory brick includes attaching anchors to the support member, and co-molding the support member and anchors into the refractory brick.

24. The method according to claim 18, further comprising attaching mounting tabs to a second surface of the support member.
